(19) United States
(12) Patent Application Publication
(10) Pub. No.: US 2025/0105667 A1
(43) Pub. Date: Mar. 27, 2025

(54) SPACE HEATER WITH WIRELESS CHARGING DOCK FOR REMOTE CONTORL

(71) Applicant: Matthew Slack, Las Vegas, NV (US)

(72) Inventor: Matthew Slack, Las Vegas, NV (US)

(21) Appl. No.: 18/471,696

(22) Filed: Sep. 21, 2023

(51) Int. Cl. H02J 50/10; F24H 3/04; H02J 7/00

(52) U.S. Cl. CPC H02J 50/10; F24H 3/0417; H02J 7/0044

(57) ABSTRACT

According to an aspect of the present invention, a space heater having wireless charging capability, comprising: a space heater frame; a heating element; a power source; a wireless charging dock positioned within the space heater frame; a remote control; and a rechargeable battery positioned within the remote control, wherein the wireless charging dock is configured to charge the internal rechargeable battery positioned within the remote control.

### BACKGROUND

Space heaters generally operate to heat a small space without needing to use a ducted heating system. Space heaters can radiate heat via a ceramic heating unit or use a fan to circulate hot air, or both. Though some space heaters could burn a solid or a liquid fuel, commonly space heaters are electric. Remote controllers which control operations of these types of space heaters are known.

For example, U.S. Pat. No. 9,310,097 discloses a remote controller which may be included with the heating system to control operation of the heater. Additionally, the remote controller may include a display to provide operational feedback to a user. The remote controller may be connected to the heater via a wired and/or wireless connection. For example, the remote controller may operate wirelessly to control the heater. The remote controller may also include an option to connect to the heater via a wired connection to control the heater, charge the remote controller, and/or otherwise operate the heating system.

However, prior art does not disclose efficient means for connecting a remote controller to a space heater for wireless charging.

### SUMMARY OF INVENTION

Therefore, the present invention provides a space heater with a wireless charging dock for a remote control. When the remote is placed in the dock, the remote will charge wirelessly.

According to an aspect of the present invention, there is provided a space heater having wireless charging capability, comprising: a space heater frame; a heating element; a power source; a wireless charging dock positioned within the space heater frame; a remote control; and a rechargeable battery positioned within the remote control, wherein the wireless charging dock is configured to charge the internal rechargeable battery positioned within the remote control.

### BRIEF DESCRIPTION OF THE DRAWINGS

FIG. 1 illustrates a perspective view of a space heater according to an embodiment including a remote control with wireless charging capability.

FIG. 2 illustrates a front view of a space heater according to an embodiment including a remote control with wireless charging capability.

FIG. 3 illustrates the interior components of a space heater according to an embodiment including a remote control with wireless charging capability.

FIG. 4 illustrates a cross-sectional view of a space heater according to an embodiment including a remote control with wireless charging capability.

FIG. 5 illustrates an interior view of a space heater according to an embodiment including a remote control with wireless charging capability.

FIG. 6 illustrates another interior view of a space heater according to an embodiment including a remote control with wireless charging capability.

FIG. 7 illustrates a space heater according to an embodiment plugged into a wall.

### DETAILED DESCRIPTION

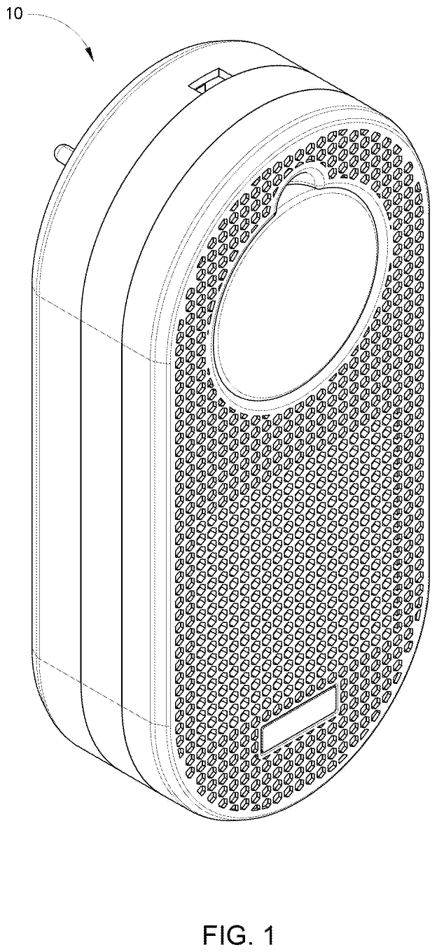

FIG. 1 illustrates a perspective view of a space heater according to an embodiment including a remote control with wireless charging capability.

Device 10 is a space heater according to an embodiment. The space heater in embodiments can plug directly into an electrical outlet, or it can have a cord which connects to an outlet. It could be small and meant to heat a bedroom. It can have a digital display. In an embodiment the digital display can be removable and used as a remote control. It can have a little groove above the display in which a person can dig in a finger in to remove a remote control.

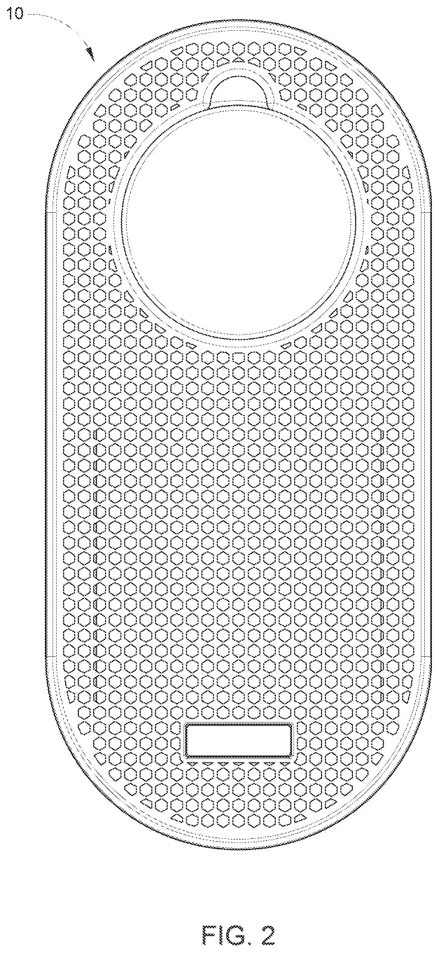

FIG. 2 illustrates a front view of a space heater according to an embodiment including a remote control with wireless charging capability.

Device 10 including a heater and wireless charger can both be powered from an electrical socket, but it could have a cord or be cordless. The remote control can have a battery in it, much like a phone. The battery could be an internal battery or it could be removeable. The way it charges is wirelessly. Inside the heater is a wireless ring on which the wireless charging coil is placed. It uses electromagnetic induction to provide electricity to portable devices. The primary coil in the charger induces a current in the secondary coil in the device being charged. The remote control can be placed near the dock positioned within the heater without needing to be precisely aligned or make electrical contact.

Inductive charging is named so because it transfers energy through inductive coupling. First, alternating current passes through an induction coil in the charging station or pad. The moving electric charge creates a magnetic field, which fluctuates in strength because the electric current's amplitude is fluctuating. This changing magnetic field creates an alternating electric current in the portable device's induction coil, which in turn passes through a rectifier to convert it to direct current. Finally, the direct current charges a rechargeable battery.

Rechargeable batteries are produced in many different shapes and sizes, ranging from button cells to megawatt systems connected to stabilize an electrical distribution network. Several different combinations of electrode materials and electrolytes are used, including lead-acid, zinc-air, nickel-cadmium (NiCd), nickel-metal hydride (NiMH), lithium-ion (Li-ion), lithium iron phosphate (LiFePO4), and lithium-ion polymer (Li-ion polymer).

Rechargeable batteries typically initially cost more than disposable batteries but have a much lower total cost of ownership and environmental impact, as they can be recharged inexpensively many times before they need replacing. Some rechargeable battery types are available in the same sizes and voltages as disposable types, and can be used interchangeably with them.

The remote control can also be magnetized so that the remote is able to stay in the dock when it is not pulled out. Areas of a magnet that have magnetic strength are called poles. Like poles repel, or push, each other. Opposite poles attract, or pull, each other. Thus, the north pole of a magnet on the remote will click together with the south pole of another magnet in the dock, or vice-versa.

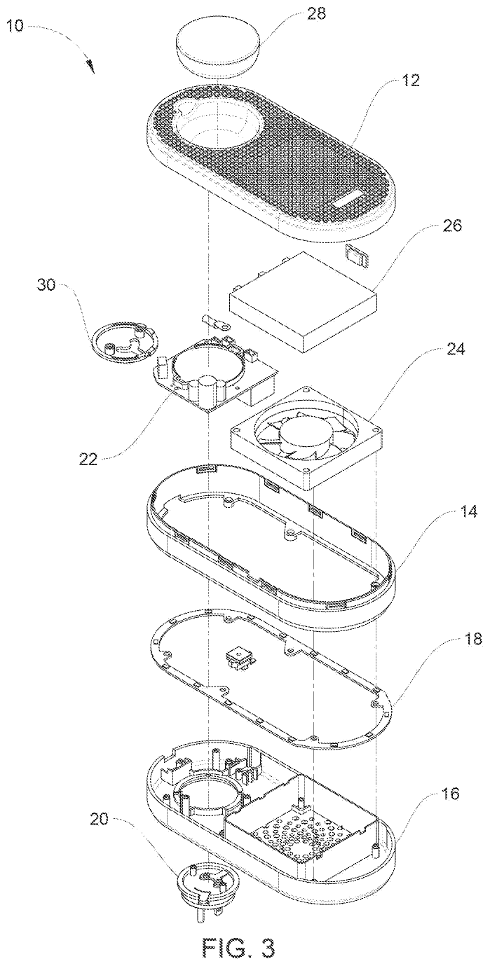

FIG. 3 illustrates the interior components of a space heater according to an embodiment including a remote control with wireless charging capability.

First housing 12 and second housing 16 enclose the components of device 10 on the top and bottom. Middle housing 14 encloses the components of device 10 on the side. Sealing gasket 18 between second and middle housing seals the middle and second housing.

Plug 20 connects device 10 to a power outlet.

Electronics 22 provide control units for device 10.

Fan 24 provides a fan element blowing hot air.

Heating element 26 provides a radiative heating element.

Remote control and display 28 is removeable and can function both as a remote control and a display.

Wireless charging ring 30 provides wireless charging capability for remote control and display 28.

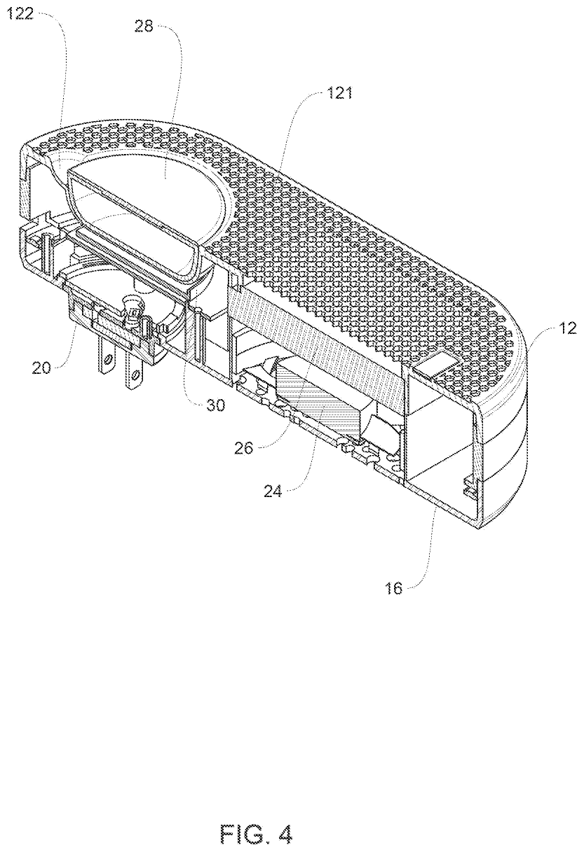

FIG. 4 illustrates a cross-sectional view of a space heater according to an embodiment including a remote control with wireless charging capability.

First housing 12 and second housing 16 enclose the components of device 10 on the top and bottom.

Vents on first housing 121 allow for ventilation of device 10.

Groove for pulling out the remote control 122 proves a space for a person to stick their finger and remove remote control 28.

Plug 20 connects device 10 to a power outlet.

Fan 24 provides a fan element blowing hot air.

Heating element 26 provides a radiative heating element.

Remote control and display 28 is removeable and can function both as a remote control and a display.

Wireless charging ring 30 provides wireless charging capability for remote control and display 28.

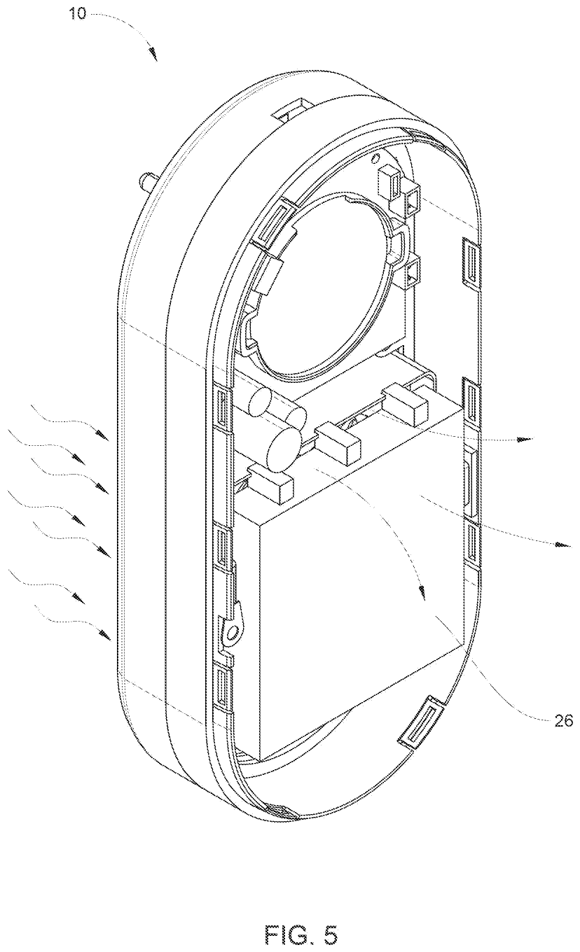

FIG. 5 illustrates an interior view of a space heater according to an embodiment including a remote control with wireless charging capability. Device 10 has radiative heating unit 26 which is the operative part of device 10.

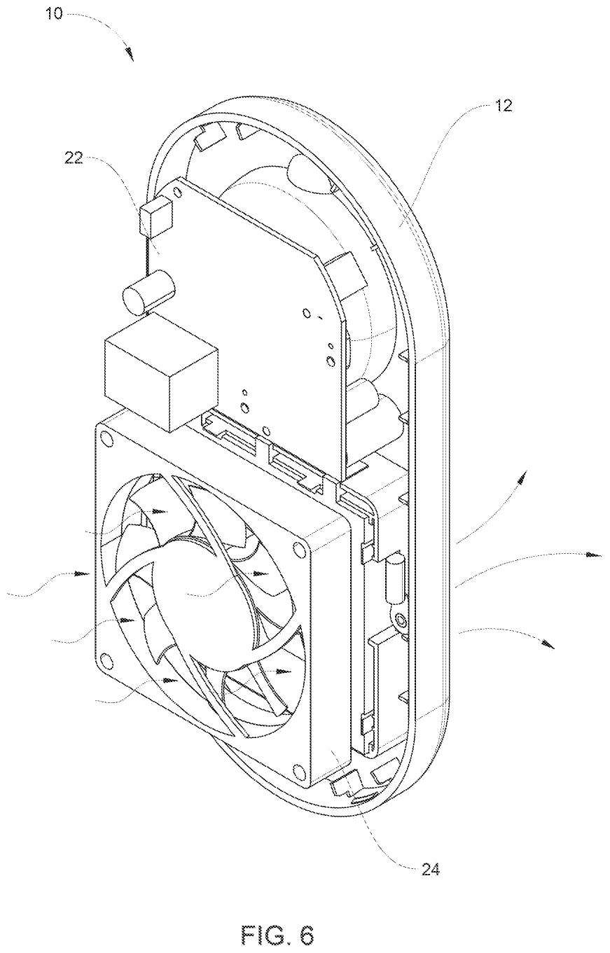

FIG. 6 illustrates another interior view of a space heater according to an embodiment including a remote control with wireless charging capability.

First housing 12 encloses the components of device 10 on the top. Electronics 22 provide a control unit for device 10. Fan 24 provides a fan element blowing hot air.

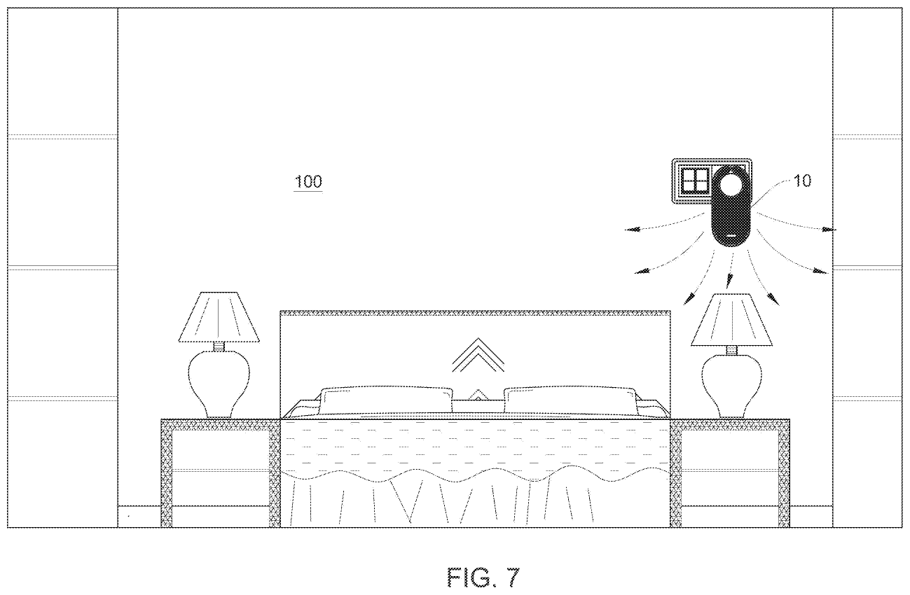

FIG. 7 illustrates a space heater according to an embodiment plugged into a wall. Device 10 heats room 100 via radiative heating and/or a fan blowing hot air. An LED light can be provided on the outer ring of the unit in some embodiments.

Having thus described a few particular embodiments of the invention, various alterations, modifications, and improvements will readily occur to those skilled in the art. Such alterations, modifications, and improvements are intended to be part of this description though not expressly stated herein, and are intended to be within the spirit and scope of the invention. Accordingly, the foregoing description is by way of example only of several of many potential embodiments, and not limiting. The claims are not intended to import any limitations from the description in the specification of the exemplary embodiments.

What is claimed is:

1. A space heater having wireless charging capability, comprising:
a space heater frame;
a heating element;
a power source;
a wireless charging dock positioned within the space heater frame;
a remote control; and
a rechargeable battery positioned within the remote control,
wherein the wireless charging dock is configured to charge the internal rechargeable battery positioned within the remote control.

2. The space heater having wireless charging capability of claim 1, wherein the heating element comprises a ceramic heating unit.

3. The space heater having wireless charging capability of claim 1, wherein the heating element utilizes a fan to circulate hot air.

4. The space heater having wireless charging capability of claim 1, wherein the remote control is provided with a magnet.

5. The space heater having wireless charging capability of claim 4, wherein the magnet in the remote control is attracted to a magnet with an opposite pole provided within the wireless charging dock.

6. The space heater having wireless charging capability of claim 1, wherein the remote control comprises a digital display.

7. The space heater having wireless charging capability of claim 1, wherein the rechargeable remote control battery is a nickel-cadmium battery, nickel-metal hydride battery, or lithium-ion battery.

8. The space heater having wireless charging capability of claim 1, further comprising a cord for the heater to plug into a wall outlet.

9. The space heater having wireless charging capability of claim 8, wherein the wireless charging dock is also powered by the wall outlet.

10. The space heater having wireless charging capability of claim 1, wherein the heater plugs directly into a wall outlet.

11. The space heater having wireless charging capability of claim 10, wherein the wireless charging dock is also powered by the wall outlet.

12. The space heater having wireless charging capability of claim 1, wherein the rechargeable battery is an internal battery.

13. The space heater having wireless charging capability of claim 1, wherein the rechargeable battery is a removeable battery.

14. The space heater having wireless charging capability of claim 1, further comprising a LED light provided on the space heater frame.
